(19) United States
(12) Patent Application Publication
(10) Pub. No.: US 2011/0145016 A1
(43) Pub. Date: Jun. 16, 2011

(54) SECURE DATA CARD

(75) Inventors: Kamran Eshraghian, Perth (AU); Kyoungrok Cho, Taejon City (KR)

(73) Assignee: IDATAMAP PTY. LTD., Leeming (AU)

(21) Appl. No.: 12/993,995

(22) PCT Filed: May 20, 2009
(86) PCT No.: PCT/AU09/00623

§ 371 Date: Feb. 15, 2011

(30) Foreign Application Priority Data
May 22, 2008 (AU) 2008902530

(51) Int. Cl. G06Q 50/00; G06F 12/14

(52) U.S. Cl. 705/3; 713/189

(57) ABSTRACT

An apparatus for storing information has a input device to allow a user to communicate with the apparatus and to allow the apparatus to output information to said user; a storage portion including a compression device to compress information stored in the storage portion; and a cipher to perform multilayered encryption and decryption to allow the passing and receiving of the information stored on the apparatus in a secure manner.

### FIELD OF THE INVENTION

The present embodiment relates to a method and apparatus for a secure and private data card for use ensuring the privacy and security of personal information. In particular, the apparatus provides a secure and private data card for use in the health care industry.

### BACKGROUND TO THE INVENTION

Over a lifetime, an individual's medical records are often distributed over a range of locations often separated by large distances. Even though this medical information is regularly needed, its wide distribution over multiple locations does not lend itself to efficient communication. Each time you change location or require medical attention away from your local health care provider, you are required to complete an information sheet providing such information as contact details and a medical history summary. This replication of information is stored by each health care provider each time you change location, change name should you get married or each time you require medical attention. This also leads to the problem of not having up to date medical information on file at each of the above multitude of locations and different health providers. For example, if you were to attend a different medical health provider, your local general practitioner would not receive any details of the treatment which was carried out by the different medical health provider and therefore would not have an up to date medical history.

Even when records are available, they are primarily in the form of paper-based charts or local computer databases which are maintained by each health care provider. The combination of paper-based charts and computer records contain voluminous handwritten encounter notes, test results, files, hospital discharge summaries, diagnostic evaluations, laboratory images, etc. The difficulty of reviewing, extracting, and communicating vital information quickly from both the paper charts and computer records is a known, serious problem.

Several types of medical card technologies have been developed. There are medical cards with barcodes, magnetic stripes, optical and microprocessor chip technology, all competing technologies. Microfiche medical cards have also been proposed over the years but they have not proliferated because they are very difficult to update. Special cards, usually of plastic media format, may hold a patient identification (ID) and personal identification (pin) number. Barcodes which are imprinted on the surface of plastic cards normally contain patient ID and pin number information which are used to retrieve the patient's medical records from remote computer databases. The barcode imprint is normally fixed and the barcode itself has limited storage capability.

These competitive card technologies are competing for industry-wide acceptance. A broad acceptance is a prerequisite for success because these systems depend upon special electronic equipment which could be installed in all locations. The cost of the patient card media along with the administrative and maintenance costs of backup and regeneration of potentially large amounts of medical information is also a consideration should a card be lost or damaged. The special hardware and software requirement may make these solutions somewhat unattractive.

A further concern is the privacy and confidentiality of the information, as the unauthorised release of medical records, particularly in this information age, is a recognised problem.

The reference to any prior art in this specification is not, and should not be taken as, an acknowledgement or any form of admission that the prior art forms part of the common general knowledge in Australia or else where.

It is therefore desirable to provide an apparatus and method of providing a secure and private data card that overcomes or alleviates one or more of the above described disadvantages.

### SUMMARY OF THE INVENTION

Broadly, the present invention provides a data card which is secure and readily accessible and capable of storing information such as text, graphics, audio or video.

In one aspect of the present invention, there is provided an apparatus for storing information comprising:
a input device to allow a user to communicate with said apparatus and to allow the apparatus to output information to said user;
a storage means comprising a compression device to compress information stored in said storage portion; and
a cipher means to perform multilayered encryption and decryption to allow the passing and receiving of said information stored on said apparatus in a secure manner.

In a further aspect of the present invention, there is provided an apparatus for storing information comprising:

a tangible medium comprising:
a user identification and password to enable the tangible medium to identify a user;
a first storage portion comprising a compression device to compress information stored in said first storage portion;
a second storage portion comprising uncompressed information stored in said second storage portion;
a cipher means to perform multilayered encryption and decryption to the information stored on said tangible medium;
a global information technology standard for displaying and storing said information stored in said first storage portion and said second storage portion.

In a further aspect of the present invention, there is provided a system for storing information comprising:

a personal computer to allow a user to input and output information;

a docking device connected to said personal computer to allow an apparatus for storing information to communicate with said personal computer;

a apparatus for storing information comprising:
a user identification and password to enable the apparatus to identify a user;
a storage portion comprising a compression device to compress information stored in said storage portion;
a cipher means to perform multilayered encryption and decryption to the information stored on said apparatus;
a global information technology standard capable of displaying and storing said information stored in said storage portion;

In still a further aspect of the present invention, there is provided a method for storing information, said method including:

inputting information into a apparatus for storing information to allow a user to communicate with said apparatus and to allow said apparatus to output information to said user;

storing said information in a storage portion of said apparatus, said information being compressed for storage in said storage portion;

performing multilayered encryption and decryption to allow the passing and receiving of said information stored on said apparatus in a secure manner.

In still a further aspect of the present invention, there is provided a device for storing information including:

an input means;

a storage medium; and

a cipher means;

wherein information received by said input means for storage on said storage medium is transferred to said storage medium via said cipher means, said information being encrypted by said cipher means.

The present invention provides an information storage card which is secure, durable and readily accessible. The apparatus provides a record of personal medical data that addresses the clinician's need for ready and convenient access to patient information, and is a key example of the benefits of a person-centric data model in health care. This new technology applies a person-centric data model to the health system and influences the delivery of health care worldwide, saving imaging costs, but also offering process savings and other efficiencies within the wider health care system.

The multilayered encryption technology permit only authorized physicians, nurses, pharmacists, lab technicians and business office personnel to access the patient record as required. This means that the card polices access by different classes of users to different sections of its data.

### BRIEF DESCRIPTION OF THE DRAWINGS

The present invention will be understood more fully from the detailed description given hereinafter and from the accompanying drawings of the preferred embodiment of the present invention, which, however, should not be taken to be limitative to the invention, but are for explanation and understanding only.

FIG. 1 shows a perspective view of a device according to one aspect of the present invention;

FIG. 2 shows a block diagram of the main components of the device of FIG. 1;

FIG. 3 is a further block diagram of the device of FIG. 1 showing the DICOM controller having a direct link to the terabit memory according to one aspect of the present invention;

FIG. 4 is a block diagram of a device according to the present invention showing the relationship between the DICOM controller, the cipher chip and the terabit memory storage;

FIG. 5 is a block diagram of a DICOM controller showing the relationship between the analog converter, the controller and the embedded processor components of the device according to one aspect of the present invention;

FIG. 6 is a block diagram of the encryption device cipher chip showing the relationship between the block and convolution components according to one aspect of the present invention;

FIG. 7 is a block diagram of the flash memory component of the device according to one aspect of the present invention showing the storage elements ID, personal information, file name, encryption, and data;

FIG. 8 is a block diagram of the relationships within the security function showing the personal computer (PC) including its DICOM window; the ID checker and the encryption/decryption function according to one aspect of the present invention;

FIG. 9 is a diagram showing the incorporation of a device according to the present invention within a mobile telephone;

FIG. 10 is a block diagram showing the use of a device according to one aspect of the present invention for memory address encryption (MAE), which uses the advanced encryption standard (AES) function to encrypt and decrypt the root directory address;

FIG. 11 is a block diagram showing an overall system for the transceiver/cipher-decipher/memory according to one aspect of the present invention;

FIG. 12 shows an encrypted key construction and how it is applied to the memory address according to one aspect of the present invention;

FIG. 13 shows a further block diagram of an encrypted key in use according to one aspect of the present invention; and

FIG. 14 shows a flow chart for the implementation of a system according to one aspect of the present invention.

### DESCRIPTION OF PREFERRED EMBODIMENT

The present invention will be discussed hereinafter in detail in terms of the preferred embodiment of a secure data card according to the present invention with reference to the accompanying drawings. In the following description, numerous specific details are set forth in order to provide a thorough understanding of the present invention. It will be obvious, however, to those skilled in the art that the present invention may be practiced without these specific details.

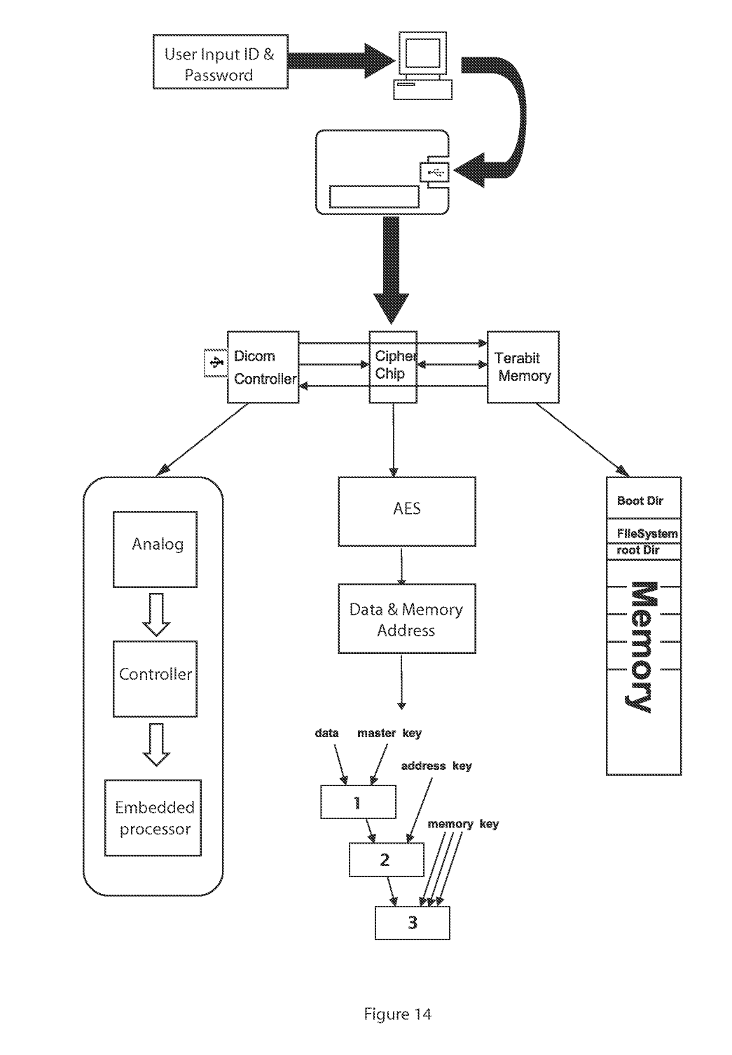

FIG. 14 and the following is an example of how the current invention could be used for transferring information from a radiologist to the clinician.

The current workflow regarding medical imaging from radiology begins with the clinician making the image request. Radiology then processes the request and in the case of CTs, for example, selects a number of slices that the radiologist feels addresses the clinician's need. A Radiologist then writes a report and sends the selected images, his report, and possibly (although unlikely) non-diagnostic quality digital images on CD to the clinician. The majority of the information (all unselected slices of the CT scan in this case) is not passed on to the clinician via the patient. However, these images are maintained digitally (in DICOM format) on the Radiologist's Picture Archiving and Communication System (PACS). The PACS holds the images in a form that currently can only be accessed through the Radiologist's local computer workstations. The images cannot be accessed in the clinician's offices because of access protocols, data security issues and most importantly, inadequate bandwidth.

A single CT scan is about 300 MB, and for example in one clinic seeing say 40 patients, as much as 20 GB could commonly be required at a moments notice for each patient. While the old technology of film has disadvantages, it at least was instantaneous, diagnostic quality and patient portable.

Thus, in a practical sense, diagnostic quality digital images are not available to the clinician at point of contact with the patient. Further, these images may not be maintained in the long term by the health system.

Even in a hospital environment, it is not possible to achieve the data transfer rates needed to allow the clinician timely reference to diagnostic quality images. With large medical images, adequate bandwidth is today generally present only on closed local networks. While Internet speeds vary with national investments in infrastructure, the Internet generally will not in the foreseeable future have the bandwidth, reliability, or short response time needed for a medical image transmission system that competes with patient carried transparencies.

A portable, personal image storage device according to the present embodiment will provide to this need. A mobile medium could safely and securely store the massive data requirements of diagnostic quality imaging including X-Ray, CT, and video. This portable device can be carried with the patient directly from the radiologist to the clinician for quick and accurate diagnosis. Such a device would not only provide the clinicians with the information needed for optimum diagnosis and treatment planning, it could carry the patient's medical imaging history, providing obvious diagnostic advantages. Additionally, it can be used to transfer other forms of high definition digital health images having large data storage and security requirements such as used in pathology and haematology.

In a preferred arrangement the present invention provides a device for storage, encryption and connectivity that will enable users to selectively engage a multitude of health care systems. The preferred embodiment involves a personal multilayered security medical data card which is capable of storing a person's personal medical history including any one of but not limited to such items as contact details, medical history summary, records of each visit to a health care provider, test results, diagnostic evaluations and laboratory images. In particular, the laboratory images may include computed tomography (CT) or magnetic resonance imaging (MRI) scans saved as video files along with software to compress the image files.

Due to the requirement to ensure confidentiality and privacy of information, the preferred embodiment provides a secure data card incorporating multilayered security. This includes the encryption and decryption of the data stored on the personal medical data card and preferably also includes memory address encryption and decryption. The cipher means used to implement the encryption and decryption of information ideally uses the advanced encryption standard (AES), although other similar standards could also be implemented.

Encryption is the conversion of data into a form, called a cipher text, which cannot be easily understood by unauthorised persons. Decryption is therefore the process of converting encrypted data back into its original form, so it can be understood. A basic example of encryption and decryption is Morse code. Simple ciphers include the substitution of letters for numbers, the rotation of letters in the alphabet, and the “scrambling” of voice signals by inverting the sideband frequencies. More complex ciphers work according to sophisticated computer algorithms that rearrange the data bits in digital signals.

In order to easily recover the contents of an encrypted signal, the correct decryption key is required. The key is an algorithm that “undoes” the work of the encryption algorithm. The more complex the encryption algorithm, the more difficult it becomes to “break” the cipher. Encryption/decryption is especially important in wireless communications. This is because wireless circuits are easier to “tap” than their hard-wired counterparts.

The information stored on the secure data card is capable of being displayed at very high speed and easily on an inexpensive digital imaging and communications in medicine (DICOM) standard monitor and computer located in the respective clinician's surgery. DICOM is a global information technology standard that is used in virtually all hospitals worldwide, and was developed to ensure the interoperability of systems used to produce, store and display medical images. The computer also allows an input facility for clinician's data entry enabling the updating of a person's personal medical history. The present embodiment also provides a secure data card incorporating efficient memory addressing for dynamic allocation of storage for data such as video.

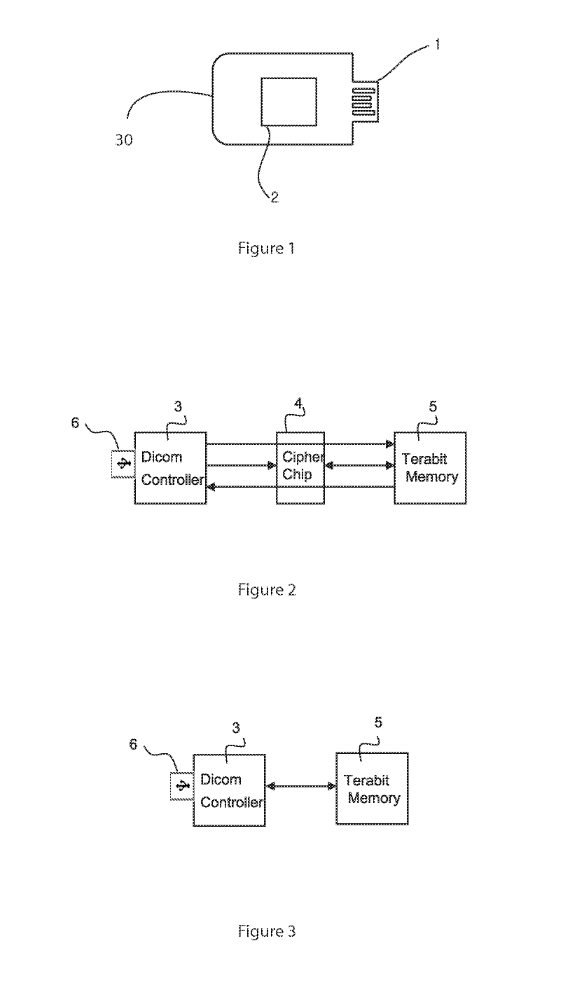

The device 30 can be a universal serial bus (USB) enabled chip as shown in FIG. 1. Other communication packages described below could also be used to implement the present embodiment.

Alternatively the device 30 may be implemented as an Ultra-Wideband (UWB) technology based on the WiMedia standard, using the convenience and mobility of wireless communications to high-speed interconnects in devices. In a further alternative the device 30 may be implemented using Bluetooth technology which incorporates an industrial specification for wireless personal area networks (PANs). Bluetooth provides a way to connect and exchange information between devices such as mobile phones, laptops, personal computers, printers, GPS receivers, and digital cameras over a secure, globally unlicensed short-range radio frequency.

In a preferred arrangement and by way of the example described above and FIG. 14, the device 30 may be supplied by a radiologist or other practitioner when issuing images. When accessing the device 30 for the first time, the user/patient would register an ID and password on a particular website. Alternatively the ID and password could be generated by the user or provided with the device 30 and then changed by the user to an ID or password which is easier for them to remember. In order to further identify and protect the user/patient a further identity code for the card is generated by an algorithm located in the firmware of the device 30. The algorithm produces an identity code based on the user name and the chosen ID and a further variable which may be for example the local time or some other variable. A password should also meet the following suggested requirements including any one of but not limited to such requirements as:
Length. By default, a password should have at least six characters. Only the first eight characters are significant. (In other words, you can have a password that is longer than eight characters, but the system only checks the first eight.) Because the minimum length of a password can be changed by a system administrator, it may be different on different systems.
Characters. A password should contain at least two letters (either uppercase or lowercase) and at least one numeral or symbol such as ©,#,%. For example, you could use dog#food or dog2food as a password, but you should not use dogfood.
Not your login ID. A password should not be the same as your login ID, nor should it be an rearrangement of the letters and characters of your login ID.

In this step it is also possible (but not essential) to add the users personal information such as name, email, other numbers, address etc.

Once an ID and password has been input by the user and if personal information has already been added it is then possible to read the personal information and the filename that are stored on the device 30. The device 30 cannot be accessed without the valid user ID and Password. The ID and Password are controlled by the USB controller 1. Depending on software used to activate the features of the card, the card may store cryptographic keys, such as a digital signature, or biometric data, such as a fingerprint. The design features tamper resistance packaging. The card can be designed to carry a fingerprint reader for another layer of security. The software used to activate the card and also used by the USB controller are based on protocols used according to the

USB standard. Preferably, the software is capable of being modified to accommodate any changes required by changing requirements.

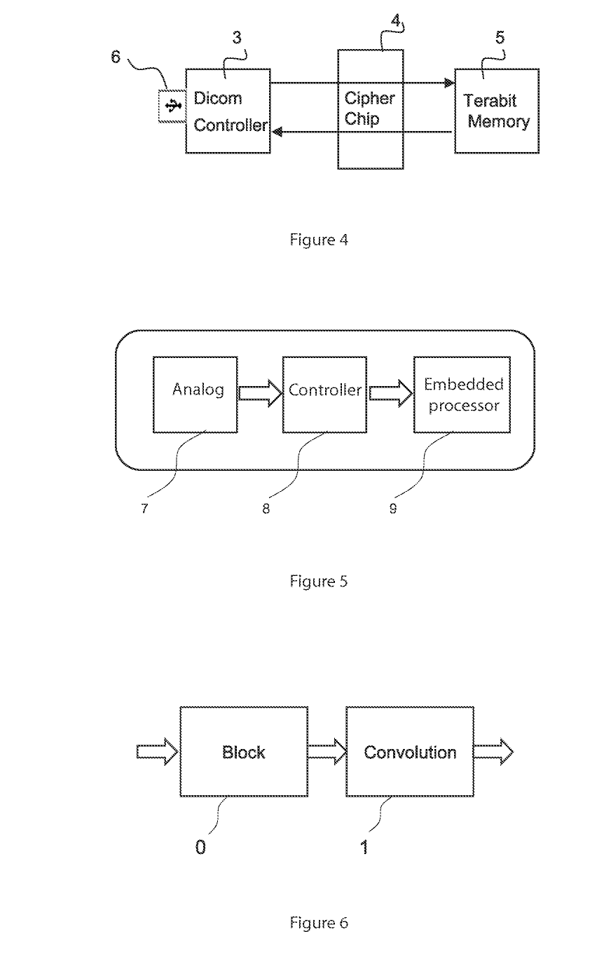

The device 30 includes a system to enable the storage of data in DICOM format as shown in FIG. 2. DICOM data may be stored in a conventional manner and without encryption as shown in FIG. 3. DICOM data may be stored using hard-wired encryption, before saving the data to memory. Hard-wired encryption means the encryption is not optionally performed by attendant software but is performed as a necessity due to the design of the hardware of the card. This means that nothing other than cyphertext can be stored on the card. Hard-wired encryption is performed in real time, each time data is saved to the card. The use of a cipher chip 4 as shown in FIG. 4 allows the real time encryption of DICOM data so that the encryption process does not appreciably increase the time taken to store data on the device 30. Alternatively other data format standards other than DICOM can be introduced into the card through development of the appropriate software and therefore all data saved under those standards will be subject to the same beneficial hard-wired encryption and other in built features of the card.

After obtaining an ID and Password via the USB controller 1, the DICOM controller 3 generates memory addresses that are passed to the memory 5, which then returns the DICOM header file to the DICOM Controller 3. The DICOM controller 3 as shown in FIG. 5 manages the change of data from the physical signalling scheme specified in the USB standard to digital and vice versa through its physical layer interface chip 7. The physical layer itself consists of physical signalling circuits and logic. This circuitry is responsible for power-on initialization, bus arbitration, reset-sensing and data signalling. Each device is also required to keep its physical circuits powered up at all times even when the device is not in use, to ensure that the “repeater” function of the standard is met.

Preferably, the physical signalling scheme described above is based on common USB packet fields used by the USB standard.

The controller (8) analyses the USB protocol. The embedded processor 9 controls both the controller 8 and the memory 5. Firmware is also loaded on the embedded processor 9. The firmware is taken to describe an operating system located on hardware that controls its basic functions. Firmware is not limited to being read-only. The firmware can be updated to give hardware new features and capabilities. The firmware also controls whether hard-wired encryption is activated in the card and whether address block encryption or data encryption is activated or both are activated. The memory 5 keeps root information of all files. Encryption information of address and data is added to the root information and is saved in the same area of the memory 5. The information is displayed when the card is plugged in a computer or when the files are being accessed. The firmware also provides other functions on the card such as machine language instructions for the processor, or configuration settings for a fixed-function device, gate array or programmable logic device.

Due to the requirement to ensure confidentiality and privacy of information, the present embodiment provides a secure data card incorporating multilayered security. The cipher chip 4 as shown in FIG. 6 carries out encryption following the Advanced Encryption Standard (AES) using a 128-byte block size and a key size of 128 bytes. Other encryption standards are possible, for example Data Encryption Standard using 56 bit keys, (DES) or Triple Data Encryption Standard using three 56 bit keys in sequence (IDES).

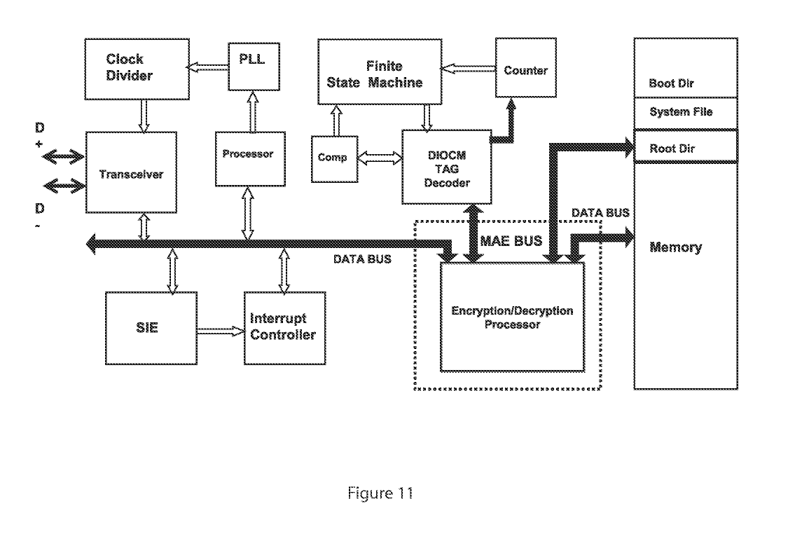

The cipher chip 4 in the preferred arrangement divides data in to 128 byte blocks 10 and then performs a convolution process 11 using the key in block 10. In FIG. 11, the memory address encryption (MAE) block diagram illustrating implementation of the invention whereby the encryption/decryption processor interfaces with memory through the data bus and with the root directory through the memory address encryption (MAE) Bus 7.

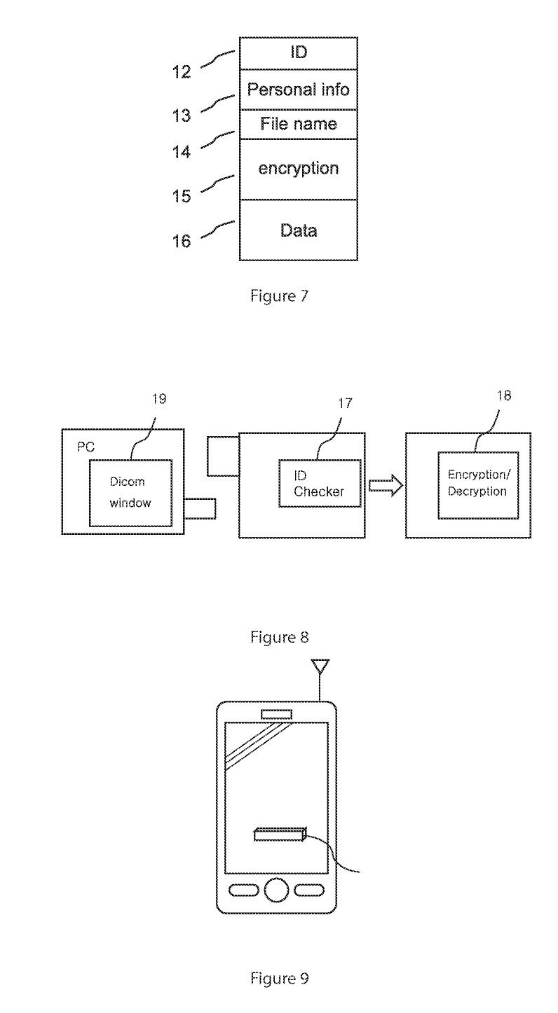

In this example the device 30 incorporates flash memory 40 as shown in FIG. 7. The flash memory stack 40 may be partitioned into ID 12 and four blocks being for Personal Information 13, File name 14, Encryption 15 and Data 16. Once the DICOM file has been obtained it is passed to the PC 19 for viewing. The security process in the device 30 is shown in FIG. 8. The security algorithm has three steps, first to check the user ID to write and to read for DICOM 17, second the encryption and description using block cryptography algorithm following AES 18 and third when the device 30 is removed from the PC 19 ensure all of the DICOM data on the PC 19 is unsavable and unwritable by deleting all of the data sitting in the DICOM window of the PC 19. The security algorithm dictates the conditions under which the USB port is opened. The data displayed on the PC is automatically flushed on removal of the card. This can be achieved with a security upgrade of the DICOM software targeted for run on the PC which is security tailored for the card.

FIG. 9 shows the implementation of the device 30 of the present embodiment in a mobile telephone 50. The device 30 may be incorporated into a mobile telephone subscriber identity means (SIM) card 20.

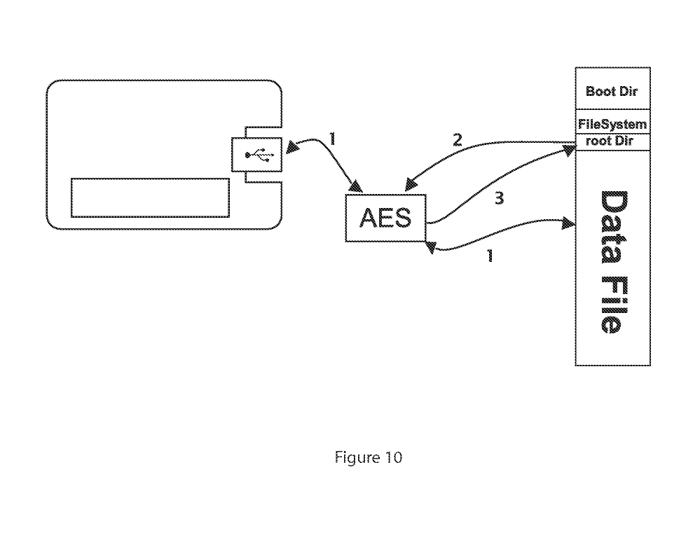

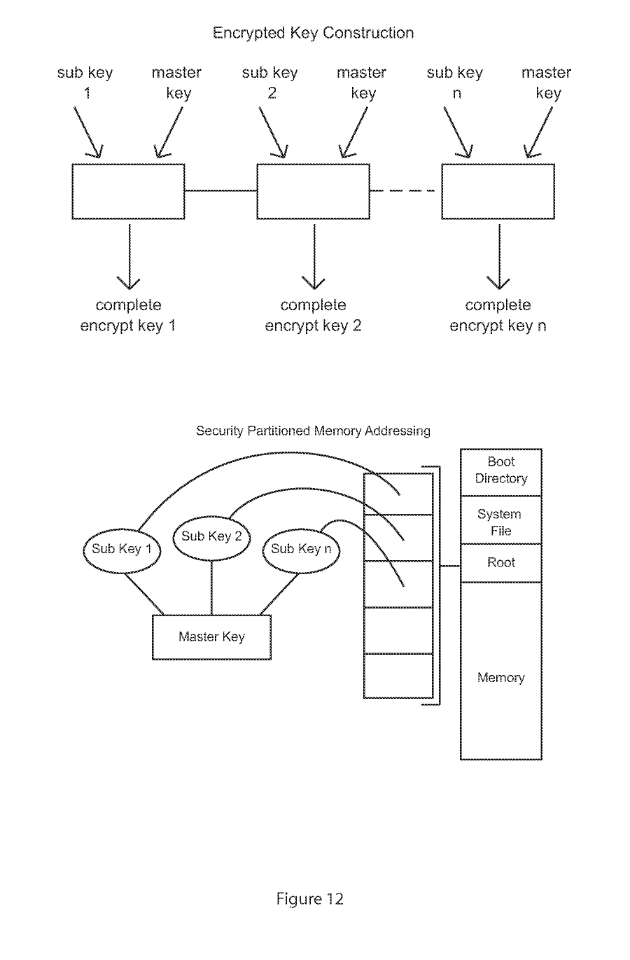

FIGS. 10 to 13 show the flow for Memory Address Encryption (MAE) technology within the device 30. This is in addition to data encryption that is used. AES provides this dual function within the device 30. The root directory (which resides within the flash memory 40) is encrypted through AES with a key that is preferably patient related or ID driven or for example, the path 2 shown in FIG. 10. The root Directory is then rewritten on the same sector of the memory (path 3 of FIG. 10). It is this root directory that provides memory addressing information.

In this example when a clinician requires to READ data from the device 30, the device 30 is connected to the PC (path 1 of FIG. 10), and provides information that the contents of the card cannot be accessed until authentication by user name and password is successful. The next step is to make the contents of the root directory available for decryption. Should any of the contents of the root directory be requested the address block is decoded by the AES using the clinician's public key and hence provides the necessary data for accessing the sector of the memory. This double protection provides additional security as part of an access control.

The data may then be read. In a preferred embodiment this data takes the form of cypher text and requires the presence of the patients encryption key, so providing a further level of security, so that without the patient, the cypher text cannot be accessed and without the clinician, the cypher text cannot be decrypted.

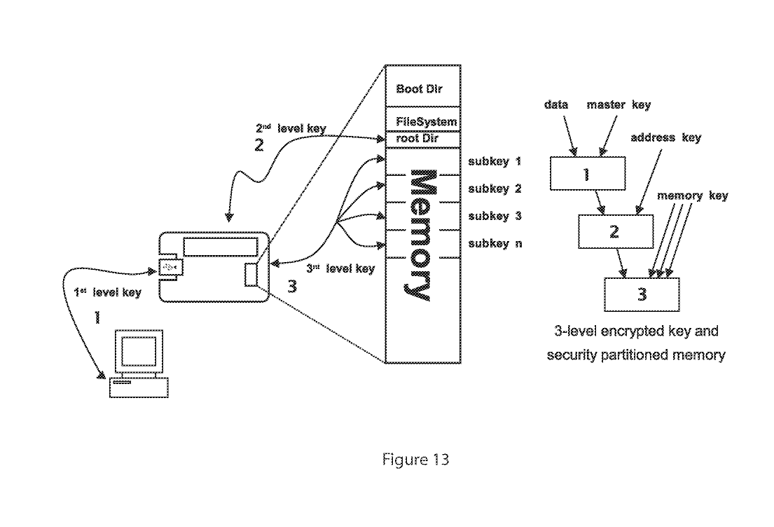

FIG. 13 further illustrates the multilayered Data/Memory address encryption. In a preferred arrangement the Level 2 and Level 3 Keys are optional also the firmware is capable of permanently activating any one or more of the three levels of keys, but gives rapid access to that sector of partitioned memory. The present embodiment provides pointers to memory sectors associated with a group. Part of the data in memory does not have to be encrypted. Other sectors are encrypted such as personal information.

As there is a need to pass sub-keys and redo the encryption so others can read the encrypted information, it was determined that re-encrypting a large quantity of data would slow this process down. In order to overcome this problem the following usage of the address/memory encryption has been included for this invention. Once a patient authenticates, and then accesses a directory listing, the address blocks are encrypted by the clinicians, so the patient cannot access the data. When a new clinician is added to the trusted circle, their public key is added to the device 30 and the device working with the particular website under Secure Sockets Layer (SSL) manages the acquisition of a master key from one of the trusted clinician's and then re-encrypts the address block, not the data block to this key. Then the new clinician can read the address block and access the stored data. The stored data is encrypted to the patient's key and is decrypted by this key as the clinician reads it. So a single read of the card requires two valid keys. The patient's public key is available to anyone after they authenticate on the card. By this means the present embodiment provides:
1. Minimal (fast) re-encryption to accommodate a new clinician in the circle; and
2. Three levels of security
   a) Authentication to patient;
   b) Address block encrypted to clinician key; and
   c) Data blocks encrypted to patient key.

A key issue achieved with the present embodiment in some arrangements is to provide a business model were speed and transparency could be delivered to the process of adding another key and supporting this over the Internet. There is also a need to provide an authentication process that automatically reports a unique and alternative user name and password. This also provides a clear beneficial usage pattern around the encryption of the address block versus data block.

Preferably to ensure that the device 30 will operate on any PC based computing environment the software will run directly from the drive as a portable application. Portable software is a class of software that is suitable for use on portable drives such as a USB (thumb) drive or iPod or Palm PDA with “drive mode”, although any external hard drive could theoretically be used.

To be considered portable a software program should not require any kind of formal installation onto a computer's permanent storage device to be executed, and can be stored on a removable storage device such as USB flash drive, enabling it to be used on multiple computers. Settings are stored with, and can be carried around with, the software (i.e., they are written to the USB drive).

Digital Radiology is accomplished by applying the DICOM standard for saved medical imaging data. This standard is embodied by vendors of Picture Archiving and Communications Systems (PACS) as used by radiology practices worldwide. Whenever new images are created by medical imaging equipment they will be loaded by a Radiologist onto the device 30 through the PACS and in DICOM standard. Then subject to the security controls of the invention, the card will store and display the images to the best quality available on the monitors connected to the PC. If the health industry, indeed any industry, uses other standards either open or proprietary then the device 30 can be used in conjunction with any of these other data standards to ensure information is saved in a consistent format under an appropriate level of security.

Preferably it is also envisaged in the future that the device 30 will work in parallel with other related technologies, such as fourth generation wireless data transfer. It will be possible to utilize direct sequence Code Division Multiple Access (CDMA) signaling to achieve higher bit rates. For example using Nomadic Local Area Wireless Access (NLA)—4G ultra high-speed mobile communications—3.5 Gbs at speed is of 5 Km/h—it is possible for high quality video streaming and is compatible with a patient entering a surgery. This new mobile communications technology dubbed “NoLA” will allow a user to download data at 3.6 Gbps, which is higher than 1 Gbps, an international benchmark for 4G mobile communications.

In simple terms the present invention provides a portable yet secure way of allowing a person's medical history to be stored and easily accessible. A person is supplied with a storage device, which may take the form of a data card. The card is authenticated to the particular user and access to the card will be governed by the user entering a security or PIN code.

The card will be able to store a variety of data including the users personal and contact information, notes and records from various practitioners, and any images or tests carried out on the user.

On presenting to a medical practitioner, the user would also supply the data card. Depending on the implementation, the data card may be presented upon entry to the medical practitioner's offices, so that any data may be downloaded prior to consultation with the medical practitioner. Alternatively, the user may keep the card and present it personally to the medical practitioner upon consultation. In order for the card to be accessed it will be necessary for the user following presentation of the card to then input the user's PIN code. This would then grant access to the card.

It is envisaged that the present invention will take advantage of the AES encryption standard, although of course other encryption standards could be utilised. In the preferred arrangement the user will have a private key and also a public key. The private key will not be disclosed to any other party, whereas the public key can be disclosed to the various medical practitioners who will consult with the user. Similarly, those various medical practitioners will have their own private and public keys. When a new medical practitioner is engaged, there can in essence be an exchange of public keys between the user and the medical practitioner.

Whilst it is possible that the data alone will be encrypted, the preferred arrangement of the present invention will also encrypt the address block of the storage device. It is the address block which enables a computer to locate where on a storage device the various data is stored. If the address block is encrypted, and thus unable to be read, a computer will not be able to access the data on the card. Accordingly, in the preferred arrangement, the address block will be encrypted using the user's private key. In this way only those medical practitioners who have been provided with the user's public key will be able to obtain access to a decrypted version of the address block.

During consultation any notes or comments which the medical practitioner makes can be added to the medical card. Further, results of any tests or scans may also be stored onto the card. In the preferred arrangement this data will be encrypted as part of the storage process, and encryption will be carried out via the medical practitioner's private key. Ideally, the memory on the medical card may be partitioned such that one area stores the user's personal details, such as their current address, and thus may be edited numerous times. The other section which stores the various medical records and findings of the medical practitioners would ideally be a write only area so that any records entered cannot at a later date be deleted or altered.

Depending on the implementation, it may also be preferable that the user not be able to read the various findings of the medical practitioners. Alternatively, there may be various sections which include full details from the medical practitioners which are not readable by the user, and another section which does provide comments for the user. In an arrangement where the user is not to be able to read the medical practitioner's comments, then rather than provide the user with the medical practitioner's public key, the public key is only then provided to other medical practitioners.

In a further embodiment it may be that a group of medical practitioners, or a class of medical practitioners are provided with the same private and public keys. This would for example allow ease of access and simplicity where a group of practitioners operate from the same premises.

The present invention therefore provides an improved way of storing medical data, and allows a user to ensure that their medical records are available to any medical practitioner to whom they consult. It also means that the various medical practitioners may no longer be required to maintain a patient's medical history and the notes from the various medical practitioners. This would of course lead to a decrease in both the management and storage required for the medical practitioners.

The card would also enable a secure means for the various data to be transferred between the various medical practitioners, whilst also maintaining the various contact details up to date and in one location. It would also mean that a user no longer needs to complete contact details whenever they consult a different medical practitioner.

The device itself also provides a multi-level security to ensure the integrity of the data. To access the data it is necessary for a user to insert a PIN or security code, the user's public key must also be known to ensure access to the address block, and the public keys of the various medical practitioners would also be required in order to decrypt the data stored on the card.

It will of course be appreciated that the reverse situation could be implemented, that is that the medical practitioner's private key is used to encrypt the address block, and the user's private key is used to encrypt the data.

In the preferred arrangement all the necessary applications will be stored directly on the card. This means that when the card is input into the system, that data is automatically encrypted and decrypted as necessary.

Throughout the specification, unless the context requires otherwise, the word “comprise” or variations such as “comprises” or “comprising”, will be understood to imply the inclusion of a stated integer or group of integers but not the exclusion of any other integer or group of integers.

Although the present embodiment has been illustrated and described with respect to exemplary embodiment thereof, it should be understood by those skilled in the art that the foregoing and various other changes, omission and additions may be made therein and thereto, without departing from the spirit and scope of the present embodiment. Therefore, the present embodiment should not be understood as limited to the specific embodiment set out above but to include all possible embodiments which can be embodied within a scope encompassed and equivalent thereof with respect to the feature set out in the appended claims.

1. An apparatus for storing information comprising:
a input device to allow a user to communicate with said apparatus and to allow the apparatus to output information to said user;
a storage portion comprising a compression device to compress information stored in said storage portion; and
a cipher means to perform multilayered encryption and decryption to allow the passing and receiving of said information stored on said apparatus in a secure manner.

2. The apparatus of claim 1, wherein said cipher means further comprises encryption and decryption of memory addresses.

3. The apparatus of claim 1, wherein said information stored on said apparatus comprises personal medical data, said personal medical data comprising:
a person's personal identification information;
a person's medical history; and
a person's medical images.

4. The apparatus of claim 3, wherein the personal medical data is saved using Digital Imaging and Communications in Medicine (DICOM) technology and displayed using a DICOM compatible monitor.

5. The apparatus of claim 4, wherein the DICOM technology comprises a DICOM controller which manages the change of data from analog to digital and digital to analog.

6. The apparatus of claim 1, wherein the cipher means allows real time encryption and decryption of the stored information.

7. The apparatus of claim 6, wherein the real time encryption and decryption of the memory address comprises dynamic allocation of information.

8. The apparatus of claim 6, wherein the cipher means further comprises an encryption and decryption processor which interfaces with a flash memory device through a data bus and through a root directory for a Memory Address Encryption (MAE) bus.

9. The apparatus of claim 1, wherein the multilayered encryption and decryption comprises an Advanced Encryption Standard (AES) block cipher.

10. The apparatus of claim 1, further comprising a user identification and a password which are registered via a global computer network such as the Internet.

11. The apparatus of claim 1, further comprising a docking station to insert the apparatus for storing information into, the docking station allows a computer to read the apparatus and also allow a user to input information to the apparatus via a user interface.

12. The apparatus of claim 11, further comprising when the apparatus for storing information is removed from the docking station the multilayered encryption ensures that any information which had been displayed on a DICOM monitor is deleted.

13. An apparatus for storing information comprising:
a tangible medium comprising:
a user identification and password to enable the tangible medium to identify a user;
a first storage portion comprising a compression device to compress information stored in said first storage portion;
a second storage portion comprising uncompressed information stored in said second storage portion;
a cipher means to perform multilayered encryption and decryption to the information stored on said tangible medium;
a global information technology standard for displaying and storing said information stored in said first storage portion and said second storage portion.

14. The apparatus of claim 13, wherein said global information technology standard comprises a digital imaging and communications in medicine (DICOM) standard.

15. The apparatus of claim 13, wherein said user identification and said password are registered via a global computer network such as the internet.

16. The apparatus of claim 13, wherein the multilayered encryption and decryption comprises an Advanced Encryption Standard (AES) block cipher.

17. The apparatus of claim 13, wherein the cipher means allows real time encryption and decryption of the stored information.

18. The apparatus of claim 17, wherein the cipher means encrypts and decrypts stored information and memory addresses.

19. The apparatus of claim 17, wherein the cipher means further comprises an encryption and decryption processor which interfaces with a flash memory device through a data bus and through a root directory for a Memory Address Encryption (MAE) bus.

20. A system for storing information comprising:
a personal computer to allow a user to input and output information;
a docking device connected to said personal computer to allow an apparatus for storing information to communicate with said personal computer;
said apparatus for storing information comprising:
a user identification and password to enable the apparatus to identify a user;
a storage portion comprising a compression device to compress information stored in said storage portion;
a cipher means to perform multilayered encryption and decryption to the information stored on said apparatus;
a global information technology standard capable of displaying and storing said information stored in said storage portion;

21. The system of claim 20, wherein said information stored on said apparatus comprises personal medical data, said personal medical data comprising:
a person's personal identification information;
a person's medical history; and
a person's medical images.

22. The system of claim 21, wherein the personal medical data is saved using Digital Imaging and Communications in Medicine (DICOM) technology and displayed using a DICOM compatible monitor.

23. The system of claim 22, wherein the DICOM technology comprises a DICOM controller which manages the change of data from analog to digital and digital to analog.

24. The system of claim 20, wherein the cipher means allows real time encryption and decryption of the stored information.

25. The system of claim 24, wherein the cipher means encrypts and decrypts stored information and memory addresses.

26. The system of claim 25, wherein the real time encryption and decryption of the memory address comprises dynamic allocation of information.

27. The apparatus of claim 25, wherein the cipher means further comprises an encryption and decryption processor which interfaces with a flash memory device through a data bus and through a root directory for a Memory Address Encryption (MAE) bus.

28. The apparatus of claim 20, wherein the multilayered encryption and decryption comprises an Advanced Encryption Standard (AES) block cipher.

29. The apparatus of claim 20, wherein said user identification and said password are registered via a global computer network such as the internet.

30. The apparatus of claim 20, further comprising when the apparatus for storing information is removed from the docking station the multilayered encryption ensures that any information which had been displayed on the DICOM monitor is deleted.

31. The apparatus of claim 210 wherein said global information technology standard comprises a digital imaging and communications in medicine (DICOM) standard.

32. A method for storing information, said method comprising:
inputting information into a apparatus for storing information to allow a user to communicate with said apparatus and to allow said apparatus to output information to said user;
storing said information in a storage portion of said apparatus, said information being compressed for storage in said storage portion;
performing multilayered encryption and decryption to allow the passing and receiving of said information stored on said apparatus in a secure manner.

33. A device for storing information comprising:
an input means;
a storage medium; and
a cipher means;
wherein information received by said input means for storage on said storage medium is transferred to said storage medium via said cipher means, said information being encrypted by said cipher means.

34. The device of claim 33, wherein said cipher means further encrypts a memory address of said storage medium.

35. The device of claim 33, wherein said device further comprises a compression means to compress information received by said input means prior to storage on said storage medium.
